(19) United States
(12) Patent Application Publication
(10) Pub. No.: US 2002/0062528 A1
(43) Pub. Date: May 30, 2002

(54) Multi-purpose tool

(76) Inventor: Jaeyoul Kang, Sungnam City (KR)

Correspondence Address: HOFFMAN WASSON & GITLER, 2361 JEFFERSON DAVIS HIGHWAY, SUITE 522, ARLINGTON, VA, 22202

(21) Appl. No.: 09/793,500

(22) Filed: Feb. 27, 2001

(30) Foreign Application Priority Data
Nov. 28, 2000 (KR) 2000-33256

(51) Int. Cl. B25B 7/22

(52) U.S. Cl. 7/137

(57) ABSTRACT

The present invention relates to a multi-purpose tool to perform a various functions as a one tool. More particularly, there is provided a multi-purpose tool including: straight teeth and sloping teeth which are formed at the lower end of the side of the body; straight teeth, U-shaped teeth and sloping teeth which are formed at the upper part of the vertical motion part which is formed monolithically at the upper side of the left handle; an upholding side and a groove to pull out a nail which is formed at the lower part of the vertical motion part; a hexagonal groove which is formed at the side of the vertical motion part; a pliers-fixing-part which is tightly upheld to the upper side of the body; a pliers-freely moving-part which is formed at the end of the upholding stand extended lengthily to the left handle; a cutting part and a electric wire hole which are formed at the top and bottom of the moving plate of left and right handles; several catching projections which are formed above and below inside the holding part of left and right handles; a lower catching projection which is formed at the shoulder part of the left handle; an upper catching projection which is formed at the end of the upper left side of the right handle and is popped up to the lower part; a joint hole which is formed at the bearing to which the axis is fixed; and a sharp striking part is which formed at the upper end of the side of the body according to a multi-purpose tool where a rod is joined to a freely moving part formed inside of the body and the left and right handles are installed to move freely according to the axis fixed at the lower side of the body as a supporting point, thereby improving the work efficiency by shortening the working hour because many different kinds of functions can be performed by one tool and this gets rid of the complication of keeping tools with different functions separately and of searching them each time they are needed.

### BACKGROUND OF THE INVENTION

1. Field of the Invention

The present invention relates to a holding tool which can be used in driving a nail. More particularly, the invention relates to a multi-purpose tool which can be used as a hammer, a spanner, a pincer, pliers, or a tool for holding and removing a concrete nail.

2. Discussion of Related Art

Generally, all kinds of tools, such as a tool to drive a concrete nail, a hammer, a spanner, a pincer, a driver, and pliers are needed in the field of industry, or at home. Conventional tools with one function have been the cause of diminution of work efficiency, since each tool needs to be stored separately and to be looked for whenever needed. Recently many different kinds of multi-purpose tools have been developed to enable one tool perform various functions. However, these conventional multi-purpose tools could be used for only two or three functions. That is, they were made to perform similar functions such as a hammer and a pincer; or pliers, a wire cutter, and a wire cover remover, and were not able to perform multiple functions at once as one tool. As a result, to work in the field of industry or at home, various kinds of tools need to be prepared, stored separately, looked for whenever necessary, which delayed work speed and therefore caused lower efficiency.

### SUMMARY OF THE INVENTION

The present invention has been studied and developed to solve the traditional problems described above. The objective of this invention is to improve the efficiency by adding various functions to a concrete nail driver so that it can have multiple functions. Therefore, one tool does all the work, saving the trouble of keeping each tool in separate places and searching for each of them whenever needed.

It is another object of the present invention to make the storage and carrying of the tool convenient by minimizing the tool size even though various functions are combined into one tool.

### BRIEF DESCRIPTION OF THE ATTACHED DRAWINGS

FIG. 1 is a perspective view of a tool according to the present invention;

FIG. 2 is a partly cut side view of a tool according to the present invention that shows the using state of a tool; and

FIG. 3 is a side view of a tool according to the present invention when a left handle is opened.

### DETAILED DESCRIPTION OF PREFERRED EMBODIMENT

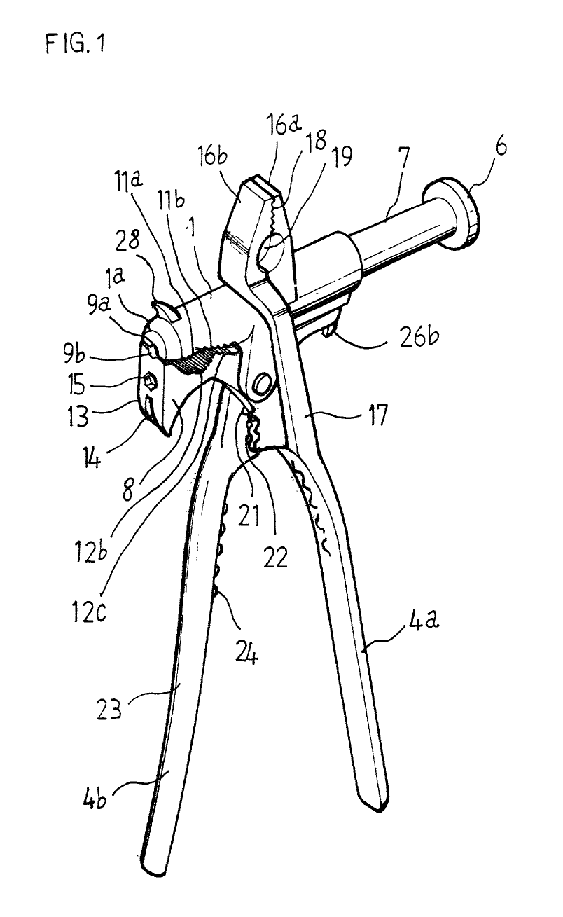

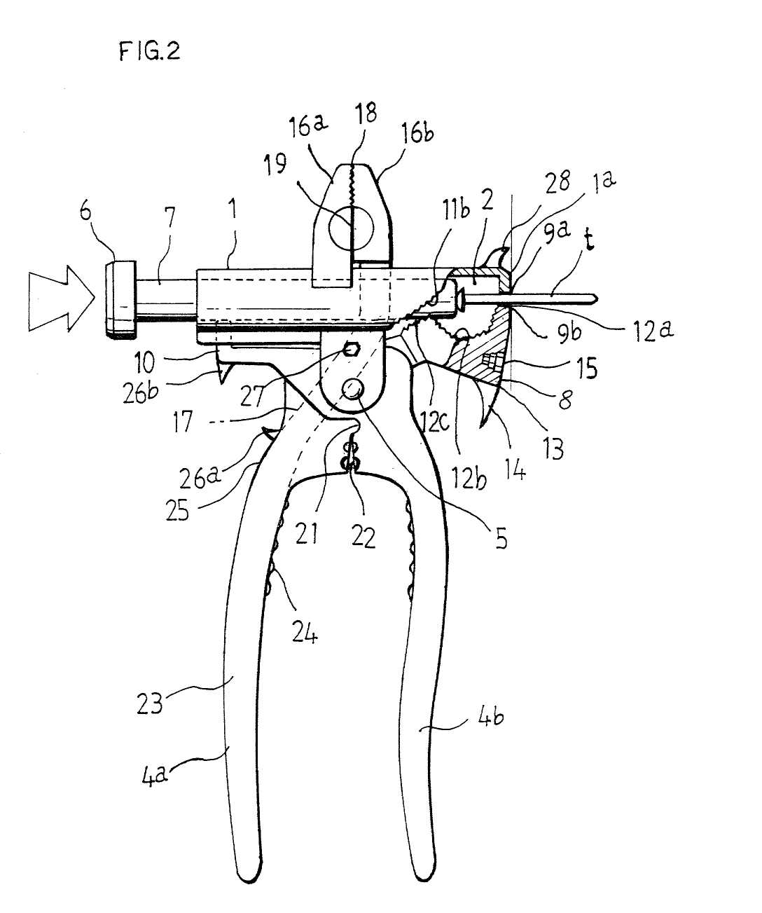

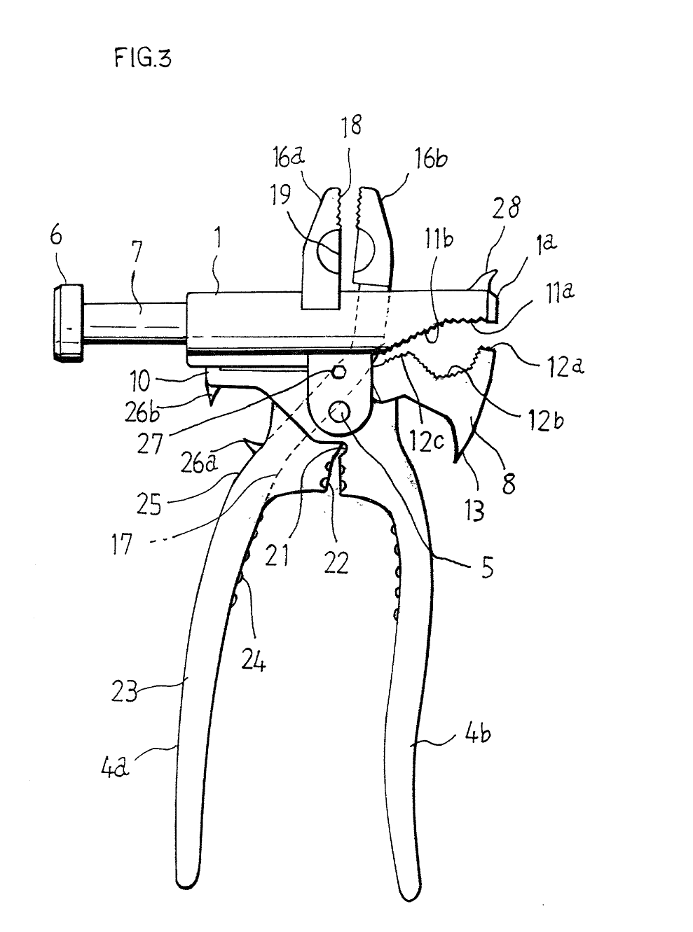

FIG. 1 is a perspective view of the present invention, FIG. 2 is a partly cut side view that shows the using state a tool, and FIG. 3 is a side view of a tool when a left handle is opened.

In the present invention, as described in FIG. 1, a monolithic bearing 3 is formed at the lower part of the body 1 which is equipped with a freely moving part 2 inside and as the axis 5 fixed at the bearing 3 an anchor point, left and right handles 4a, 4b are installed so that they can move freely left and right. A rod 7 that has a hammer head 6 at one end is joined to the inside of the freely moving part 2 so that it can move left and right.

At the upper right corner of the left handle 4a, vertical motion part 8 is monolithically formed. At the upper part 8a of the vertical motion part 8 and at the side 1a of the body 1 a holding groove 9a, 9b that supports concrete are installed, respectively. A catching part 10 that is popped out at the upper left corner of the right handle 4b is joined to penetrate the freely moving part 2 so that the rod 7 can be closely upheld by the end of the catching part 10.

Also, at the lower end of the side 1a of the body 1, straight line teeth 11a and sloping teeth 11b are formed, and at the upper side of the vertical motion part 8, straight line teeth 12a, U-shaped teeth 12b, and sloping teeth 12c are formed, respectively so that the tool can function as a spanner, a pipe ranch, and tweezers using the teeth 11a, 11b located at the upper side and teeth 12a, 12b, 12c located at the lower side.

Also, along the lower part of the vertical motion part 8, an upholding side 13 is formed lengthily and the groove 14 to pull out the nail is formed at the center of the upholding side 13 so that it can function as a pincer. A hexagonal groove 15 is formed in a multi-stage method at the side of the vertical motion part 8 so that the tool can perform the upholding function of a bar spanner.

Also, at the upper side of the body 1, a pliers-fixing-head 16a is attached and at the end of the upholding stand 17 extended to the upper part of the left handle 4a, a pliers-freely moving-head 16b is formed. The pliers-fixing-head 16a, the teeth 18 of the pliers-freely moving-head 16b and a cross section 19 are joined in opposite direction so that the tool can function as pliers.

Furthermore, at the lower part of the axis 5 of right and left handles 4a, 4b, a plate type moving plate 20a, 20b are formed, a cutting part 21 is formed at the upper part of the moving plate 20a, 20b, and an electric wire hole 22 is formed according to its size at the lower part of the moving plate 20a, 20b so that the tool can perform the function of wire cutting and wire covering.

In addition, several catching projections 24 are formed above and below the inside of the upper part of the holding unit 23 of left and right handles 4a, 4b so that they can function as a screwed type bottle opener. At the shoulder part 25 of the left handle 4a, a lower catching projection 26b is formed to be popped up to the upper part and at the end of the upper left side of the right handle 4b, the upper catching projection 26b is formed to be popped up to the lower part so that the tool can perform the function as a crown type bottle opener.

Also, a joint hole 27 is formed by punching on the bearing 3 so that the hexagonal upholding part of a screwdriver can be inserted.

Also, a striking part 28 is formed to be popped up at the upper part of the side 1a of the body 1 so that it can function as a window crusher.

An operating method of the present invention constructed as described above is as follows.

As illustrated in FIG. 2 of this invention, in order to drive a concrete nail t, the nail is held to the holding groove 9a, 9b and the left handle 4a is pushed to the inside. Then the vertical motion part 8 applies pressure to the upper part and concrete nail t is firmly upheld at the holding grooves 9a, 9b, so that the end of the concrete nail t, or the side 1a of the body 1, is closely upheld to the concrete wall. When a hammer head 6 as a separate hammer hits and the inertia of hammer is transferred to the concrete nail through the rod 7 and makes it nailed into the concrete wall. This operation of driving a nail can be done with less force without the nail getting bent because the concrete nail is closely upheld by the holding groove 9a, 9b and the inertia of hammer is concentrated as it is provided straightforward through a rod 7.

Also, this tool can be used as a spanner, a pipe ranch, and tweezers by using straight teeth 11a and sloping teeth 11b formed at the lower end of the side 1a of the body 1 and straight teeth 12a, U-shaped teeth 12b, and sloping teeth 12c formed at the upper side of the vertical motion part 8.

That is, between each sloping teeth 11b, 12c, a hexagonal bolt head or a nut is located and when the left handle 4a is pulled to the inside, a vertical motion part 8 applies pressure to the upper part and a bolt or a nut is closely upheld by each of the straight teeth 11b, 12c, therefore, it can be used as a spanner to fasten or disjoint a bolt or a nut.

It also can be used as a pipe ranch because the upper part of the pipe is caught by the straight teeth 11a and sloping teeth 11b and the lower part of the pipe is caught by U-shaped teeth 12b and this makes the pipe being upheld tightly. And it can function as a tweezers if various kinds of objects are placed and held between the straight teeth 11a, 12a.

In order to use this tool as pliers, the left handle 4a is pulled to the outside, then a gap is formed as it is widened from the axis 5 and the pliers-freely moving-head 16b is separated from the pliers-fixing-head 16a at the same time. Once various kinds of objects are placed in the gap, the left handle 4a is pressurized to the inside and pliers-freely moving-head is held closely to the object, which makes the holding or cutting function possible.

Also, if the left handle 4a is pulled to the outside, the cutting part 21 and the electric wire hole 22 formed on the moving plate 20a, 20b are widened. Therefore, wire to be cut or electric wire to be covered is placed at the cutting part 21 or on the wire hole 22 and the left handle 4a is pressurized to the inside so that the wire placed at the cutting part 21 can be cut and the cover of the electric wire placed on the wire hole 11 can be cut.

Also, to open a screwed type bottle cap, tightly uphold the peripheral of a bottle cap to the catching projections 24 formed inside the holding unit 23 of left and right handles 4a, 4b and rotate the cap while pressurizing the left handle to the inside.

Also the tool can be used to pull out a nail by holding the head of nail resting on a groove 14 and using the upholding side 13.

Also heads of the various kinds of bar spanners or box spanners can be joined to the hexagonal groove 15 as a bolt is fastened or disjointed by inserting the end of the bar spanner to the hexagonal groove 15 and combining a striking end to the head of a bolt.

Furthermore, the tool can be used to fasten or loose a screw when the separately constructed head of a screwdriver is inserted to the joint hole 27.

Also, if the tool of the present invention is kept in a car and to be used to crush a window for passengers to escape in case of emergency, one can break a window with less force by using the sharp end of the striking part 28.

As described above, the present invention is to develop a tool that can function as a spanner, pliers, a pincer, a can opener, a wire cutter, an electric wire covering, and a window crusher as well as a concrete nail driver. This will improve the work efficiency by shortening the working hour because many different kinds of functions can be performed by one tool and this gets rid of the complication of keeping tools with different functions separately and of searching them each time they are needed.

Also, despite that various functions are organized into one tool, the size of the tool does not getting bigger and can be minimized so that the storage and carrying is convenient.

Moreover, the present invention is a useful invention in that it does not have a defect part and the necessary functions of tools are constructed compositively so that it can be conveniently used both in the field of industry or at home.

What is claimed:

1. A multi-purpose tool comprising:
a first set of straight teeth and sloping teeth which are formed at a lower end of a side of a body;
a second set of straight teeth, U-shaped teeth and sloping teeth which are formed at an upper part of a vertical motion part which is formed monolithically at an upper side of a left handle;
an upholding side and a groove to pull out a nail which is formed at a lower part of the vertical motion part;
a hexagonal groove which is formed at a side of the vertical motion part;
a pliers-fixing-part which is tightly upheld to an upper side of the body;
a pliers-freely moving-part which is formed at an end of an upholding stand extended lengthily to the left handle;
a cutting part and an electric wire hole which are formed at a top and bottom of a moving plate of the left and right handles;
several catching projections which are formed above and below inside a holding part of the left and right handles;
a lower catching projection which is formed at a shoulder part of the left handle;
an upper catching projection which is formed at the end of the upper left side of the right handle and is popped up to the lower part;
a joint hole which is formed at a bearing to which an axis is fixed; and
a sharp striking part is which formed at the upper end of the side of the body according to a multipurpose tool where a rod is joined to a freely moving part formed inside of the body and the left and right handles are installed to move freely according to the axis fixed at the lower side of the body as a supporting point.
